(19) United States
(12) Patent Application Publication
(10) Pub. No.: US 2024/0346627 A1
(43) Pub. Date: Oct. 17, 2024

(54) METHODS AND SYSTEM FOR VIDEO PROCESSING

(71) Applicant: GUANGDONG OPPO MOBILE TELECOMMUNICATIONS CORP., LTD., Dongguan (CN)

(72) Inventors: Cheolkon JUNG, Dongguan (CN); Hao ZHANG, Dongguan (CN)

(21) Appl. No.: 18/752,328

(22) Filed: Jun. 24, 2024

Related U.S. Application Data
(63) Continuation of application No. PCT/CN2021/142649, filed on Dec. 29, 2021.

(51) Int. Cl. G06T 5/60; G06T 5/70

(52) U.S. Cl. CPC G06T 5/60; G06T 5/70; G06T 2207/10016; G06T 2207/20084

(57) ABSTRACT

Methods and a system for video processing are provided. The method includes receiving an input image; extracting shallow features of the input image through a head network; determining, based on the shallow features, residual features of the input image and enhancing a portion of the residual features by two or more weakly-connected-dense-attention-blocks (WCDABs); reconstructing the residual features to form a residual map; and adding the residual map to the input image to generate a reconstructed image.

### CROSS REFERENCE TO RELATED APPLICATION(S)

This application is a continuation of International Application No. PCT/CN2021/142649, filed Dec. 29, 2021, the entire disclosure of which is incorporated herein by reference.

### TECHNICAL FIELD

The present disclosure relates to video compression schemes that can improve coding efficiency by effectively remove compression artifacts. More specifically, the present disclosure is directed to a system and methods for video processing.

### BACKGROUND

Common image and video compression methods includes those using Joint Photographic Experts Group (JPEG) standard (e.g., for still images) JPEG as well as High Efficiency Video Coding (HEVC) and Versatile Video Coding (VVC) standards (e.g., for videos). In these methods, quantization and prediction processes are performed during the coding processes, resulting in irreversible information loss and various compression artifacts in compressed images/videos, such as blocking, blurring, and banding. This drawback is especially obvious when using a high compression ratio.

To address the foregoing drawback, multiple deep-learning based methods are used. These methods include frameworks/networks based on a pyramid structure. This type of network first extracts the features of input images at different scales, continuously up-samples the small-scale features, then fuses them with the large-scale features, and finally obtains the output of the same scale as the input images. Such methods are usually complicate and requires many convolution operations so as to process information at different scales. These methods also have strict requirements on the size of the input images and thus cannot be applied to pictures of all sizes.

Other methods include frameworks/networks based on block stacking. The most common ones are networks based on dense blocks or residual blocks. Through stacking multiple blocks, feature information can be learned and used to enhance the quality of the images. However, this type of networks is relatively simple in structure and requires a significant number of network parameters. In addition, since only a single type of block is used, the network's learning ability and feature selection ability are also limited.

Drawbacks of existing residual learning methods include that they do not fully use of the residual features in the network but only select partially residual characteristics in time. Therefore, the residual image learned by the network only includes a small part of the distortion area in the input images. As a result, improved systems and methods are advantageous to address the foregoing drawbacks.

### SUMMARY

In a first aspect, a method for video processing is provided. The method includes: receiving an input image; extracting shallow features of the input image through a head network; determining, based on the shallow features, residual features of the input image and enhancing a portion of the residual features by two or more weakly-connected-dense-attention-blocks (WCDABs); reconstructing the residual features to form a residual map; and adding the residual map to the input image to generate a reconstructed image.

In a second aspect, a system for video processing is provided. The system includes: a processor; a memory configured to store instructions, when executed by the processor, to: receive an input image; extracting shallow features of the input image through a head network; determine, based on the shallow features, residual features of the input image and enhance a portion of the residual features by two or more weakly-connected-dense-attention-blocks (WCDABs); reconstruct the residual features to form a residual map; and add the residual map to the input image to generate a reconstructed image.

In a third aspect, a method for video processing is provided. The method includes: receiving an input image; retrieving residual information of the input image by two or more weakly-connected-dense-attention-blocks (WCDABs); processing the residual information by two or more residual attention blocks (RABs) of each of the WCDAB, wherein the RAB includes a dual-branch structure having depth-wise separable convolutions having first and second branches, wherein the first branch includes a first convolutional layer with a first dimension, and wherein the second branch includes two second convolutional layers with the first dimension; enhancing the residual information by a channel-spatial-attention-block (CSAB) module of the WCDABs to form enhanced residual information; and generating a reconstructed image based on the enhanced residual information and the input image.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram illustrating a weakly-connected-dense-attention-neural-network (WCDANN) framework in accordance with one or more implementations of the present disclosure.

FIG. 2 is a schematic diagram illustrating a weakly connected dense attention block (WCDAB) of the WCDANN framework in accordance with one or more implementations of the present disclosure.

FIG. 3 is a schematic diagram of a residual attention block (RAB) in accordance with one or more implementations of the present disclosure.

FIGS. 4A and 4B are schematic diagrams illustrating common convolution and depth-wise convolution.

FIG. 5 is a schematic diagram illustrating receptive fields of a “3×3” convolution layer, a “5×5” convolution layer, and two “3×3” convolution layers in accordance with one or more implementations of the present disclosure.

FIG. 6 is a schematic diagram of a channel spatial attention block (CSAB) in accordance with one or more implementations of the present disclosure.

FIG. 7 is a schematic diagram of a spatial attention block (SAB) in accordance with one or more implementations of the present disclosure.

FIGS. 8A-8E are images illustrating testing results of the WCDANN framework in accordance with one or more implementations of the present disclosure.

FIGS. 9A-9E are images illustrating testing results of the WCDANN framework in accordance with one or more implementations of the present disclosure.

FIG. 10 is a schematic diagram of a wireless communication system in accordance with one or more implementations of the present disclosure.

FIG. 11 is a schematic block diagram of a terminal device in accordance with one or more implementations of the present disclosure.

FIG. 12 is a flowchart of a method in accordance with one or more implementations of the present disclosure.

### DETAILED DESCRIPTION

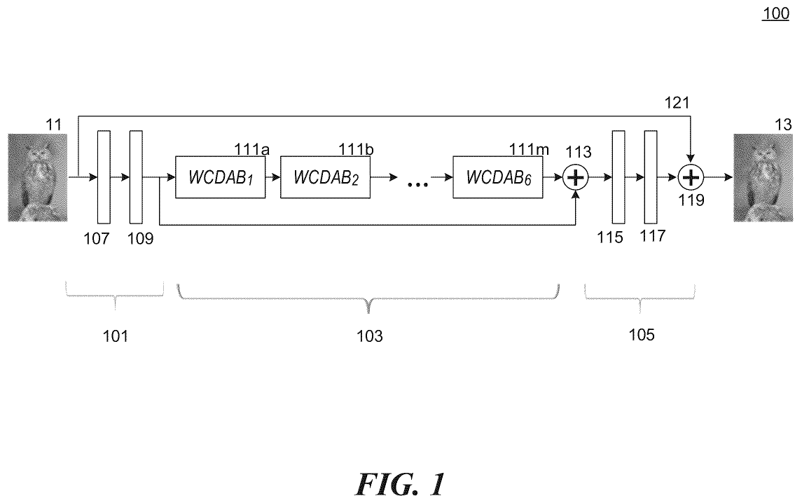

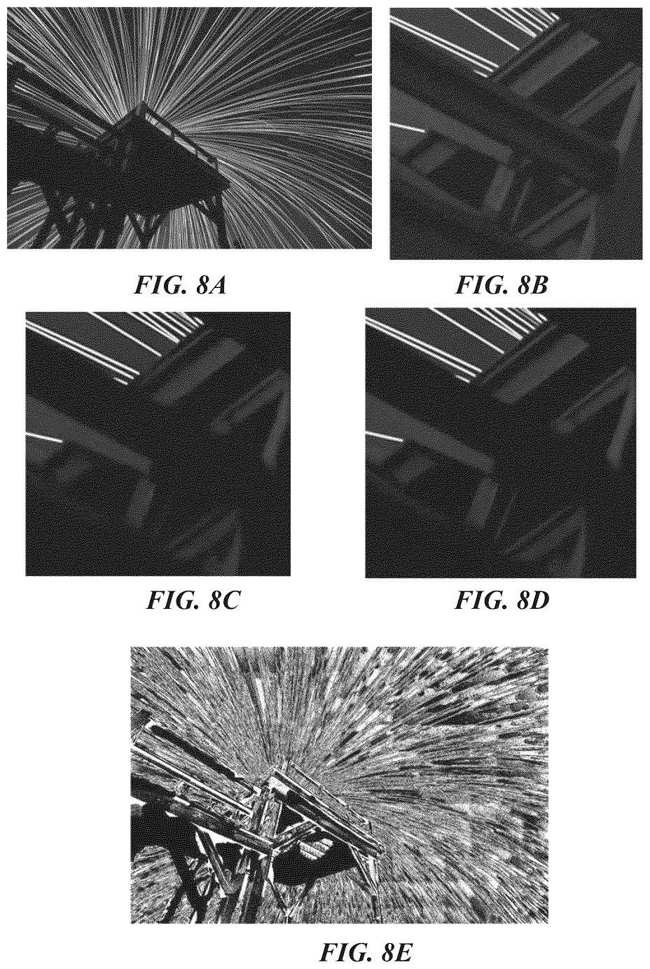

The present disclosure is related to systems and methods for improving image qualities of videos based on residual information. The residual information can be trained by deep learning and/or artificial intelligent schemes. The present disclosure provides a weakly-connected-dense-attention-neural-network (WCDANN) framework (e.g., FIG. 1) for improving image qualities of an input image based on trained residual information. The WCDANN framework improves overall image qualities of compressed images (e.g., by JPEG) and/or videos (e.g., by HEVC or VVC) by eliminating or mitigating compression artifacts (such as blocking, blurring, and banding) in images and videos. For example, testing results (FIGS. 8A-E and 9A-E) show that the WCDANN framework can effectively remove various compression artifacts and according enhances image qualities.

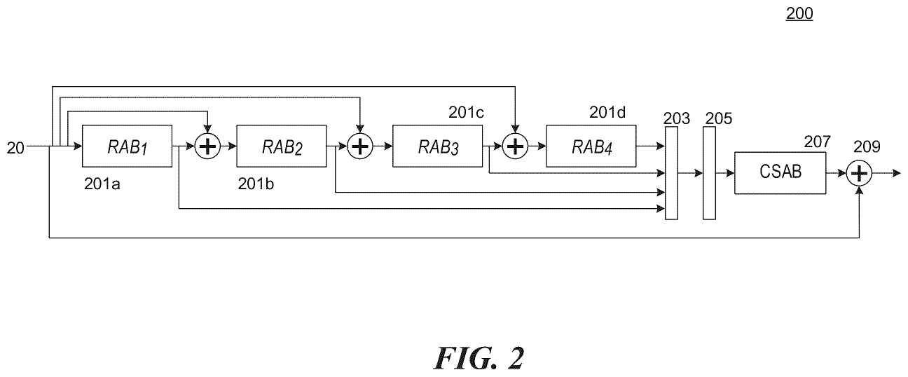

The WCDANN framework uses the residual information to improve the quality of an input image. The WCDANN framework includes multiple weakly connected dense attention block (WCDAB) to extract useful residual information from the input image (FIG. 1). The multiple WCDABs are connected such that the residual information can be circulated and processed in series. Each of the multiple WCDABs further includes multiple residual attention blocks (RABs) (FIG. 2).

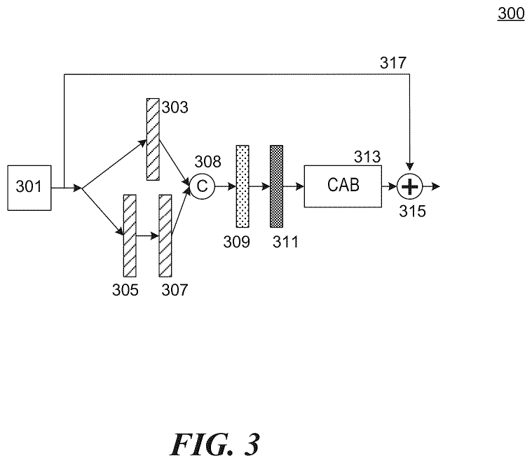

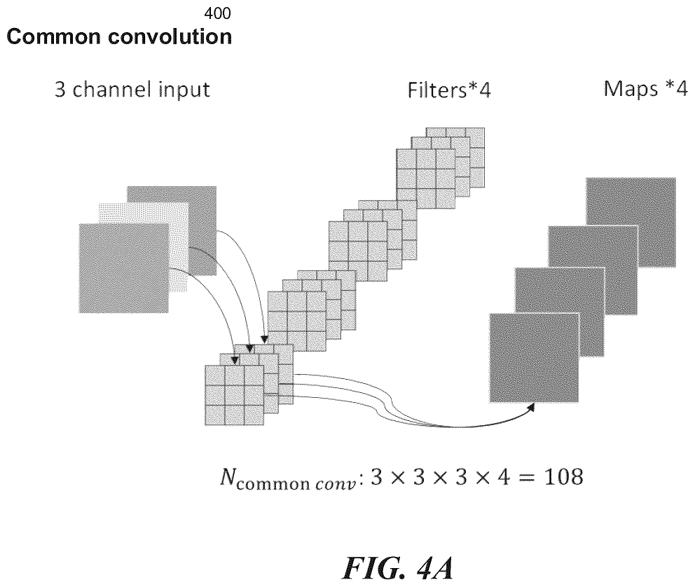

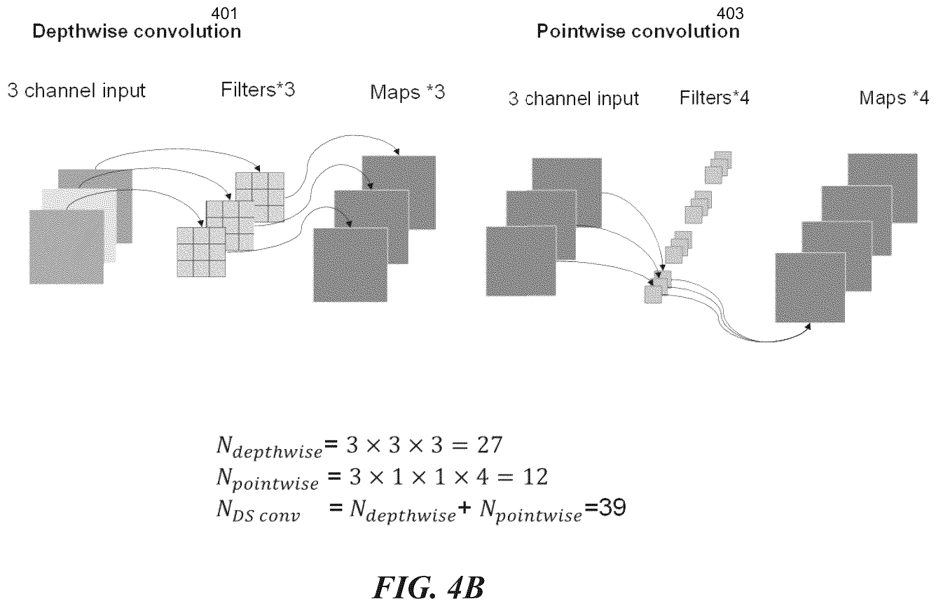

In some embodiments, the WCDANN framework includes two attention modules, channel attention block (CAB) module (in RAB) and channel-spatial attention block (CSAB) module (in WCDAB) to enhance residual features in outputs of the RABs (e.g., FIG. 3) and the WCDABs (e.g., FIG. 2). The WCDANN framework uses a “depth-wise” separable convolution method to process the RABs (FIG. 3), which greatly reduces the number of model parameters (FIGS. 4A and 4B), and therefore is a “lightweight” network. The “lightweight” RABs can be used as basic units to extract features from a large receptive field (FIG. 5) and emphasize important channels from the extracted features. By this arrangement, the present methods can effectively improve image quality with reduced amount of computing resources.

In some embodiments, the present method can be implemented by a tangible, non-transitory, computer-readable medium having processor instructions stored thereon that, when executed by one or more processors, cause the one or more processors to perform one or more aspects/features of the method described herein.

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram illustrating a weakly-connected-dense-attention-neural-network (WCDANN) framework 100 in accordance with one or more implementations of the present disclosure. The WCDANN framework 100 is configured to learn, train, and/or use residual information to improve image qualities of an input image 10. The WCDANN framework 100 includes many “residual connections” in each module therein so as to promote circulation of the residual information. As discussed in detail below, the WCDANN framework 100 uses two types of “attention modules,” which are channel-attention-block (CAB) module (in RAB) and channel-spatial-attention-block (CSAB) module (in WCDAB) to enhance features (indicated by the residual information) of each block (e.g., an image unit that includes multiple pixel components). More particularly, the WCDANN framework 100 includes multiple weakly-connected-dense-attention-blocks (WCDABs) 111a-m, and each of the WCDABs includes multiple residual attention blocks (RABs) (FIGS. 2 and 3). The RABs are configured to use “depth-wise” separable convolution processes (FIGS. 4A and 4B) to process the residual information, which greatly reduces the number of model parameters and accordingly improve the overall efficiency of the WCDANN framework 100. In some embodiments, the WCDANN framework 100 can be embedded within codecs (e.g. in-loop filter) by a block-level implementation.

As shown, the WCDANN framework 100 includes three portions, a head part (or head network) 101, a backbone part (or a backbone network) 103, and a reconstruction part (or a reconstruction network) 105. The head part 101 includes two convolutional layers 107, 109, which are used to extract features (e.g., shallow features) of the input image 10. In some embodiments, shallow features of an input image can include a feature that can be observed or identified in images related to the input image but with a lower resolution. Each of the convolutional layers 107, 109 is followed by a rectified linear unit (ReLU) activation function. Given an input “I,” through a head part network “ψ,” (shallow) feature “F₀” can be obtained from the following equation.

F₀=ψ(I)

The backbone part 103 is the key component of the WCDANN framework 100. As shown in FIG. 1, the backbone part 103 includes “M” WCDABs (M=6 in FIG. 1; in other embodiments, however, “M” can be “2-10”). The backbone part 103 receives the feature “F₀” as input, processes the residual information of the feature “F₀,” combining the calculation result at an adder 113, and then sends extracted global feature “F_{w}” to the reconstruction part 105. The process can be expressed as:

$${F}_{w} = {ω}_{M} ( {ω}_{M - 1} ( … ( {ω}_{1} ( {F}_{0} ) ) … ) ) + {F}_{0}$$

In the foregoing equation, “ω_{M}” represents the M-th WCDAB and “ω_{M-1}” represents the M−1-th WCDAB.

The reconstruction part 105 is structurally symmetrical to the head part 101. The reconstruction part 105 can be expressed as:

$$\hat{I} = χ ( {F}_{w} ) + I$$

In the foregoing equation, “Î” is a reconstructed image, and “X” represents a reconstruction network which contains first and second convolutional layers 115, 117. In some embodiments, the ReLU activation function can be used after only the first convolutional layer 115, but not the second convolutional layer 117. Without wishing to be bound by theory, this configuration can facilitate preserve the feature “F₀” and the extracted global feature “F_{w}” during the whole process.

In addition to the three parts 101, 103, and 105, the WCDANN framework 100 also directly add the input image 11 to the output of the reconstruction part 105 (e.g., at an adder 119) by means of a global residual connection 121. In this way, the WCDANN framework 100 only needs to learn global residual information (e.g., from the global residual connection 121) so as to enhance the quality of the input image 11 and to form a quality-enhanced image 13. Compared with other methods that need to learn the entire reconstructed image, the WCDANN framework 100 greatly reduces its training difficulty and learning burden.

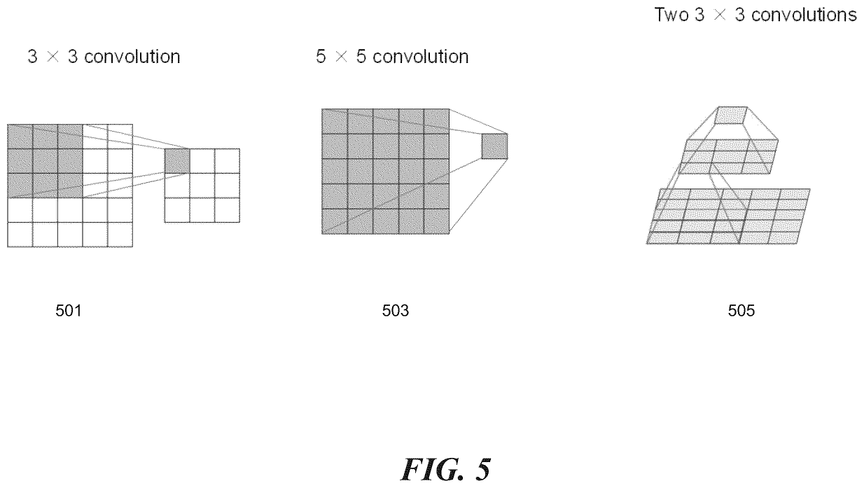

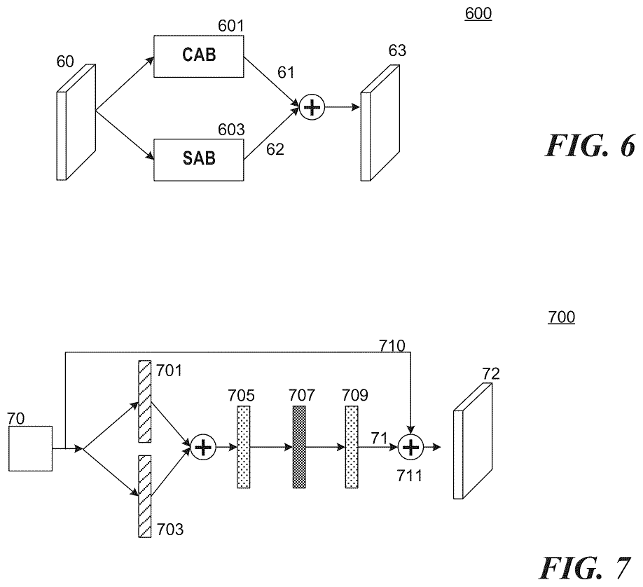

FIG. 2 is a schematic diagram illustrating a weakly connected dense attention block (WCDAB) 200 of the WCDANN framework 100 in accordance with one or more implementations of the present disclosure. As shown in FIG. 2, the WCDAB 200 includes four residual blocks (RABs) 201a-d (with an output 203), one convolutional layer 205, and one channel-spatial-attention-block (CSAB) 207. Detailed embodiments of the RABs are discussed with reference to FIG. 3. Detailed embodiments the CSAB are discussed with reference to FIGS. 6 and 7. In the illustrated embodiments, there are four RABs. In other embodiments, however, there can be 2-8 RABs.

The four RABs 201a-d are configured to extract features from an input feature 20. In some embodiments, the input feature can be extracted or identified from an input image (e.g., the input image 11 discussed with reference to FIG. 1). As shown in FIG. 2, the outputs of the RABs 201a-d are concatenated in series and is indicated as the output 203. A “1×1” convolution layer 205 is then used to reduce the channel dimension of the output 203 and form a reduced-dimensional feature map. The reduced-dimensional feature map is then directed to the CSAB to extract a channel-spatial joint attention map. The channel-spatial joint attention map is then added with the input feature 20 so as to form an output of the WCDAB 200. The overall process of the WCDAB 200 can be expressed as:

$${ℰ}_{i} = \{ \begin{matrix}{ℛ}_{i} ( {ℓ}_{i - 1} ) + {ℓ}_{i - 1} , & i < n \\ {ℛ}_{i} ( {ℓ}_{i - 1} ) , & i = n\end{matrix}$$

$${F}_{i} = ℳ ( Conv ( [ {ℰ}_{1} , … , {ℰ}_{n} ] ) ) + {F}_{i - 1}$$

In the foregoing equations, “ [symbol] ᵢ₋₁” is the input of the i-th RAB, “ [symbol] ᵢ” represents the i-th RAB (i=1, . . . , n), and n is the number of RABs in the WCDAB 200. “Fᵢ” represents an output of the i-th WCDAB. “Fᵢ₋₁” represents an input of the i-th WCDAB. “Conv” represents a common convolution layer (FIG. 4A). “ε₁, . . . , εₙ_{ᵢ}” represents a channel concatenate operation, and “ [symbol] ” represents the CSAB 207.

In the WCDAB 200, the residual information of the first n−1 RAB blocks are connected and then combined by concatenating the outputs of each RABs 201a-d. The arrangement shown in FIG. 2 at least includes following benefits. First, an effective residual map can be generated and used to enhance the quality of input images by adding residual connections to the WCDAB 200. This arrangement helps perform similar residual learning in the WCDAB 200, thereby promoting residual learning of the entire framework. Second, adding residual connections promotes the circulation of residual information in the framework. It can also prevent a gradient disappearance that can happen during a training process. Third, concatenating each RAB output to contain more residual features can improve the quality of the output residual feature map.

In some embodiments, loss functions can be used to train the WCDANN framework 100. For example, the loss functions can be used to train enhanced images generated by the WCDANN framework 100, such that these enhanced images can be as close to a raw image (e.g., ground truth) as possible. In some embodiments, L1 and L2 loss functions can be used for training the WCDANN framework 100. In some embodiments, loss function “f(x)” can be expressed as follows:

$$f ( x ) = \{ \begin{matrix}L 1 , epoch < 40 \\ L 2 , epoch \geq 40\end{matrix}$$

In some embodiments, L1 loss function can be used in early epochs, whereas L2 loss function can be used in late epochs. The reasons of setting the loss function in this way include improving training efficiency. For example, a gradient value of the L2 loss function is positively correlated with the difference between a generated image and a ground truth (e.g., an original, un-compressed image). The absolute value of the gradient value of the L1 loss is 1, which is a constant. In the early stage of training, the difference between the generated image and the ground truth can be large. The gradient value of L2 loss function can be very large compared to the gradient value of L1 loss function. When the gradient value is large, training can become very unstable. Therefore, L1 loss function is used to make the training process stable. In the late stage of training, the difference between the generated image and the ground truth is small. At this stage, if L1 loss function is used, the loss function fluctuates around a certain value and it is difficult to continue to converge. Therefore, in the late stage, L2 loss function is used to promote further convergence of loss, and accordingly enhance training efficiency.

FIG. 3 is a schematic diagram of a residual attention block (RAB) 300 in accordance with one or more implementations of the present disclosure. The RAB 300 is configured to extract features from a (large) receptive field of an image 301 and emphasize important channels from the extracted features. Parallel convolution with different receptive fields can be effective when extracting features with various receptive fields. The RAB 300 includes a “dual-branch” structure to increase its receptive field and capture multi-level information. As shown in FIG. 3, the RAB 300 includes a single “3×3” convolution layer 303 (the first branch shown in FIG. 3) and two cascaded “3×3” convolutional layers 305 and 307 (the second branch shown in FIG. 3). These convolution layers 303, 305, and 307 are configured to extract features from the image 301. The two cascaded “3×3” convolutional layers 305 and 307 can obtain a receptive field equivalent of a “5×5” convolutional layer (see, e.g., FIG. 5).

The convolution operation of both the first and second branches is a “depth-wise separable” convolution. Compared with a common convolution, the depth-wise separable convolution includes a “depth-wise” operation (e.g., 401 in FIG. 4B) and a “point-wise” operation (e.g., 403 in FIG. 4B) and accordingly it can save network parameters on the assumption of implementing the same convolution operation. FIGS. 4A and 4B illustrate the convolution layers in accordance with embodiments of the present disclosure in detail.

Referring to FIG. 4A, a common convolution layer 400, for example, can include three channel inputs and four filters (or kernels). As shown in FIG. 4A, the individual filter has a “3×3” dimension and accordingly, the overall number of required parameters for the common convolution layer 400 is “108” (i.e. 4 [maps]×3×3 [filter]×3 [channel inputs]).

FIG. 4B illustrates the structure of depth-wise separable convolution. The depth-wise separable convolution consists two parts: depth-wise convolution and pointwise convolution. As shown, the depth-wise convolution 401 also includes 3 channel inputs but the number of its filter is the same as the number of its input channels, not its output channels, and each filter is only convolved with one input channel. So, the number of the final output channels is the same as the number of the input channels. Accordingly, the overall number of required parameters for the depth-wise convolution 401 is “27” (i.e. 3×3 [filter]×3 [channel inputs]). The point-wise convolution 403 can include 3 channel inputs (shown as “3 maps” as input) with its filter only has four layers at a single point, and accordingly the overall number of required parameters for the point-wise convolution 403 is “12” (i.e. 4 [maps]×1×1 [filter]×3 [channel inputs]). As a result, the depth-wise separable convolution requires a significantly-fewer number of parameters (“27+12=39”) compared to the common convolution layer 400 (“108”). Accordingly, processes under the depth-wise separable convolution require fewer computing resources and thus more efficient.

FIG. 5 illustrates receptive fields of a “3×3” convolution layer, a “5×5” convolution layer, and two “3×3” convolution layers in accordance with one or more implementations of the present disclosure. As shown, a “3×3” convolution layer 501 calculates “3×3” convolution for each pixel. As also shown, a “5×5” convolution layer 503 calculates “5×5” convolution for each pixel. When two cascaded “3×3” convolutional layers 505 (such as the convolutional layers 305 and 307 discussed above with reference to FIG. 3) are processed, it can generate a receptive field (5×5) equivalent to a “5×5” convolution layer. Accordingly, the “dual-branch” structure of the present disclosure can effectively obtain the features of different receptive fields.

Referring back to FIG. 3, the RAB 300 includes a channel attention mechanism 308 configured to emphasize important channels from the result of processing the convolution layers 303, 305, and 307, so as to generate a feature map. Then a channel shuffling operation 309 is performed to fully integrate the features of different receptive fields at the channel level. After the channel shuffling operation 309, a “1×1” common convolution layer 311 is used to reduce the channel dimension of the output of the channel shuffling operation 309 and form a reduced-dimensional feature map. The reduced-dimensional feature map is emphasized through a channel attention block (CAB) module 313. As shown in FIG. 3, the RAB 300 then combines residual information from a residual path 317 with the processing result of the CAB module 313 at an adder 315. The overall process of RAB can be expressed as follows:

$${ℓ}_{i} = CA ( Conv ( CS [ dsConv ( {ℓ}_{i - 1} ) , … , dsConv ( dsConv ( {ℓ}_{i - 1} ) ) ] ) )$$

In the foregoing equation, “ [symbol] ᵢ” is an output of the i-th RAB, “ [symbol] ᵢ₋₁” is an input of the i-th RAB, “dsConv” stands for depth-wise separable convolution (e.g., the dual branch structure discussed above), “CS” stands for the channel shuffling operation (e.g., 309), “Conv” stands for common or ordinary convolution (e.g., 311), and “dsConv( [symbol] ᵢ₋₁), . . . , dsConv(dsConv( [symbol] ᵢ₋₁))” represents a channel concatenate operation (e.g., adding convolution channels in series), and “CA” represents the channel attention operation performed by the CAB module 313.

In some embodiments, the ReLU activate function is only used for depth-wise convolution after the pointwise convolution, rather than both depth-wise convolution and pointwise convolution. Without wishing to be bound by theory, this configuration improves the performance of the overall framework.

FIG. 6 is a schematic diagram of a channel spatial attention block (CSAB) module 600 in accordance with one or more implementations of the present disclosure. The CSAB module 600 is configured to capture channel-spatial joint attention map of residual features (e.g., the residual features identified and processed by the RAB as discussed in FIG. 3). The CSAB module 600 includes two parallel branches, a channel attention block (CAB) branch 601, and a spatial attention block (SAB) branch 603. The CAB branch 601 is configured to perform a channel attention operation (which receives input features and emphasizes certain residual features in corresponding channels so as to form a channel attention map (e.g., which indicates which channels are relatively important than others). The SAB branch 603 is configured to perform a spatial attention operation (which receives input features and emphasizes certain spatial residual features so as to form a spatial attention map (e.g., which indicates which channels are relatively important than others, from a “spatial” aspect). In some embodiments, as shown in FIG. 6, after input features 60 pass through the CAB branch 601, a channel attention map 61 is generated. After the input features 60 pass through the SAB branch 603, a spatial attention map 62 is generated. The channel attention map 61 and the spatial attention map 62 are merged through a summation operation so as to form a channel-spatial joint attention map 63.

Because the CAB branch 601 can emphasize residual features (e.g., important features such as edges of an object) by enhancing these features in corresponding channels and suppressing other features in other channels. The CSAB module 600 can be expressed as:

$$O = CA ( X ) + SA ( X )$$

In the foregoing equation, “X” represents the input of CSAB, “O” represents an output of the CSAB module 600, “CA” represents a channel attention function, and “SA” represents a spatial attention function.

In some embodiments, the channel attention function first extracts the weighting of each channel through global average pooling, channel compression and expansion, and then multiplies the extracted weighting with the input feature 60 so as to generate the channel attention map 61.

FIG. 7 is a schematic diagram of a spatial attention block (SAB) module 700 in accordance with one or more implementations of the present disclosure. The SAB 700 uses parallel convolution kernels of different sizes to convolve an input feature 70. For example, the SAB 700 includes a “1×1” convolution kernel or layer 701 and a “3×3” convolution kernel or layer 703 to process the input feature 70. Then the processing results of the convolution kernels 701, 703 are then added. An ReLU function 705 is then used to process the added results to form a feature map. After that, a depth-wise convolution 707 and then a Sigmoid operation 709 are performed on the feature map to form a spatial attention mask 71. Finally, the attention mask is multiplied with the input feature 70 (via path 710) to form a final spatial attention map 72 (at adder 711). The SAB 700 can be expressed as:

$${O}_{SA} = X * σ ( dsConv ( δ ( dsConv ( X ) + dsConv ( X ) ) ) )$$

In the foregoing equation, “X” represents an input of the SAB 700, “O_{SA}” represents an output of the SAB 700, “dsConv” represents the depth-wise convolution operation, “δ” represents the ReLU activation function, “σ” represents a Sigmoid function, and “*” represents a dot product operation.

The SAB 700 includes at least the following advantages. First, all convolutions in the SAB 700 are depth-wise convolutions. On one hand, for spatial attention, the SAB 700 only needs to pay attention to spatial information and accordingly can ignore the correlation between channels. The depth-wise convolution is only spatially convolved on feature maps of each channel, and therefore the relationships among the channels are not considered. Thus, from this viewpoint, only depth-wise convolutions are used for the SAB 700. In addition, the present CSAB 600 (FIG. 6) is to be used at the end of each WCDAB (FIG. 2). There, using depth-wise convolutions can reduce the number of parameters compared to common convolutions.

Second, because the SAB 700 calculates an attention mask for each input channel, the number of input channels and the number of the attention masks channels are the same. Accordingly, the present SAB 700 can accurately retain (important) spatial information in each channel.

FIGS. 8A-8E are images (showing “fireworks”) illustrating testing results of the WCDANN framework in accordance with one or more implementations of the present disclosure. FIG. 8A includes a raw image. FIG. 8B is an enlarged, non-compressed portion of the raw image. FIG. 8C is an enlarged, compressed portion (by VVC) of the raw image. FIG. 8D is an image enhanced by the present WCDANN framework. FIG. 8E is a residual image obtained by the present WCDANN framework. In FIG. 8D, objects in the WCDANN-enhanced compressed image have clearer edges, and artifacts in the image are also effectively suppressed.

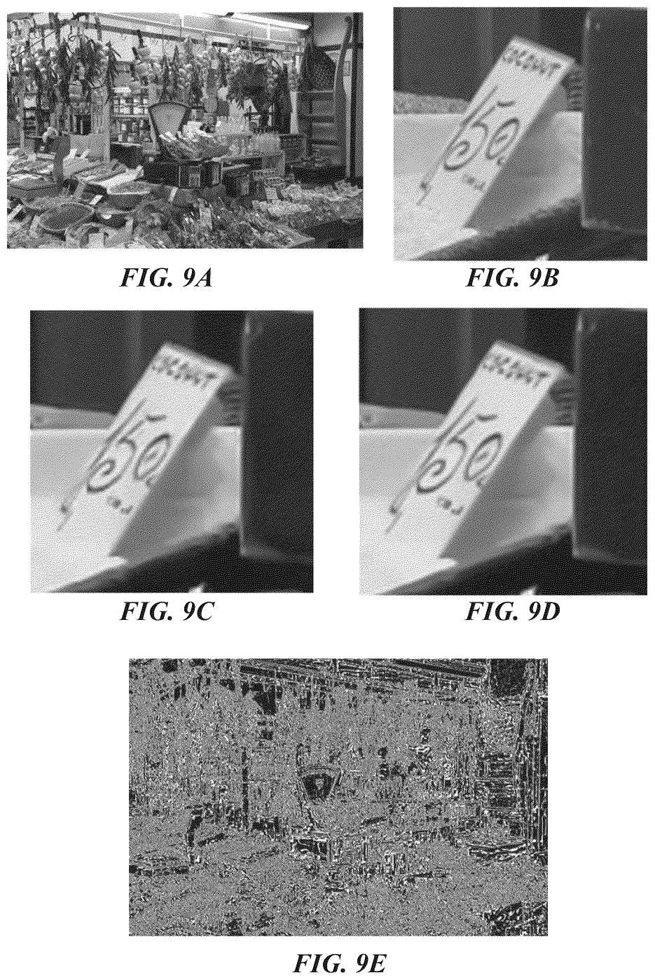

FIGS. 9A-9E are also images (showing a “market”) illustrating testing results of the WCDANN framework in accordance with one or more implementations of the present disclosure. FIG. 9A includes a raw image. FIG. 9B is an enlarged, non-compressed portion of the raw image. FIG. 9C is an enlarged, compressed portion (by VVC) of the raw image. FIG. 9D is an image enhanced by the present WCDANN framework. FIG. 9E is a residual image obtained by the present WCDANN framework. In FIG. 9D, objects in the WCDANN-enhanced compressed image have clearer edges, and artifacts in the image are also effectively suppressed.

Table 1 below shows quantitative measurements on the “firework” images (FIGS. 8A-8E) and the “market” images (FIGS. 9A-9E) in terms of Peak Signal to Noise Ratio (PSNR) and Structural Similarity (SSIM). In Table 1, “Compressed” refers to the images compressed by VVC standard, and “Enhanced” refers to the images enhanced by the present WCDANN framework. After the enhancement by the present WCDANN framework, the PSNR and SSIM values for the “firework” images increase 1.48282 dB and 0.00295, respectively. Similarly, the PSNR and SSIM values for the “market” images also increase 0.41752 dB and 0.00628, respectively. These results indicate that the WCDANN framework successfully removes compression artifacts and reconstructs high quality images in terms of visual quality and quantitative measurements.

TABLE 1

| | Compressed | Compressed | Enhanced | Enhanced |
|---|---|---|---|---|
| | PNSR | SSIM | PSNR | SSIM |
| Image | 34.54686 | 0.97991 | 36.02968 | 0.98286 |
| (Firework) | | | | |
| Image | 31.82318 | 0.91825 | 32.24070 | 0.92453 |
| (Market) | | | | |

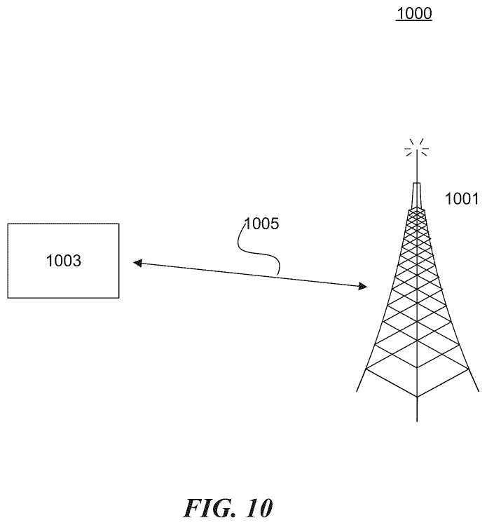

FIG. 10 is a schematic diagram of a wireless communication system 1000 in accordance with one or more implementations of the present disclosure. The wireless communication system 1000 can implement the WCDANN frameworks discussed herein. As shown in FIG. 10, the wireless communications system 1000 can include a network device (or base station) 1001. Examples of the network device 1001 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 1001 can include a relay station, an access point, an in-vehicle device, a wearable device, and the like. The network device 1001 can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), or the like. A 5G system or network can be referred to as a new radio (New Radio, NR) system or network.

In FIG. 10, the wireless communications system 1000 also includes a terminal device 1003. The terminal device 1003 can be an end-user device configured to facilitate wireless communication. The terminal device 1003 can be configured to wirelessly connect to the network device 1001 (via, e.g., via a wireless channel 1005) according to one or more corresponding communication protocols/standards. The terminal device 1003 may be mobile or fixed. The terminal device 1003 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 1003 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like. For illustrative purposes, FIG. 10 illustrates only one network device 1001 and one terminal device 1003 in the wireless communications system 1000. However, in some instances, the wireless communications system 1000 can include additional network device 1001 and/or terminal device 1003.

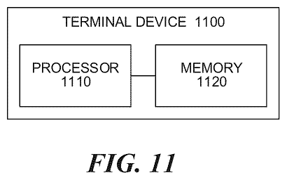

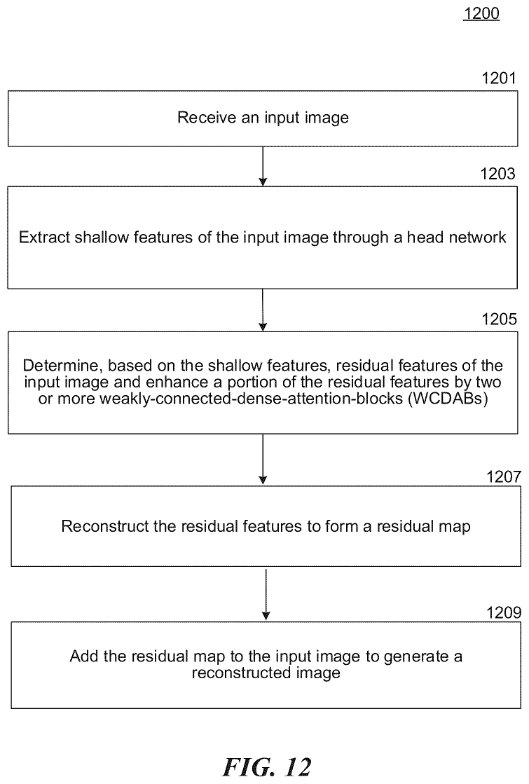

FIG. 11 is a schematic block diagram of a terminal device 1100 (e.g., which can implement the methods discussed herein) in accordance with one or more implementations of the present disclosure. As shown, the terminal device 1100 includes a processing unit 1110 (e.g., a DSP, a CPU, a GPU, etc.) and a memory 1120. The processing unit 1110 can be configured to implement instructions that correspond to the method 1200 of FIG. 12 and/or other aspects of the implementations described above. It should be understood that the processor in the implementations of this technology may be an integrated circuit chip and has a signal processing capability. During implementation, the steps in the foregoing method may be implemented by using an integrated logic circuit of hardware in the processor or an instruction in the form of software. The processor may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor may be a microprocessor, or the processor may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory, and the processor reads information in the memory and completes the steps in the foregoing methods in combination with the hardware thereof.

It may be understood that the memory in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type.

FIG. 12 is a flowchart of a method 1200 in accordance with one or more implementations of the present disclosure. The method 1200 can be implemented by a system (such as a system with the WCDANN framework 100). The method 1200 is for enhancing image qualities (particularly, for compressed images). The method 1200 includes, at block 1201, receiving an input image. At block 1203, the method 1200 continues by extracting shallow features of the input image through a head network. At block 1205, the method 1200 proceeds to determine, based on the shallow features, residual features of the input image and enhance a portion of the residual features by two or more weakly-connected-dense-attention-blocks (WCDABs).

In some embodiments, the WCDAB includes two or more residual attention blocks (RABs). The RAB can include a dual-branch structure. The dual-branch structure includes two convolution branches with different receptive fields (FIG. 3). In some embodiments, the first dimension can be the same as the second dimension (e.g., both are “3×3” as shown in FIG. 5). In some embodiments, the first dimension can be different than the second dimension.

In some embodiments, the first convolutional layer with the first dimension can correspond to a first receptive field (e.g., 3×3), and the two second convolutional layers can correspond a second receptive field (e.g., 5×5).

In some embodiments, the RAB can be configured to perform a channel shuffling operation (e.g., to integrate features from different receptive fields) after a dual-branch operation, so as to form shuffled channels corresponding to identified features. In some embodiments, the RAB can be configured to form a “1×1” common convolution layer to reduce the dimensions of shuffled channels after the channel shuffling operation, and the common convolution layer corresponds to a feature map. In some embodiments, the RAB can include a channel attention block (CAB) module configured to emphasize the shuffled channels (e.g., relatively important channels that include features of interests) in the feature map. Embodiments of the RAB are also discussed with reference to FIG. 3.

In some embodiments, the method 1200 continues by enhancing the residual features by a channel-spatial-attention-block (CSAB) module to form enhanced residual feature. In some embodiments, the CSAB module includes a channel-attention-block (CAB) branch and a spatial attention block (SAB) branch. Embodiments of the CSAB are also discussed with reference to FIGS. 3 and 6.

In some embodiments, the CAB branch can be configured to process an input feature to form a channel attention map, and the SAB branch can be configured to process the input feature to form a spatial attention map. In some embodiments, the method 1100 includes merging the channel attention map and the spatial attention map to form a channel-spatial joint attention map (e.g., FIG. 6). In some embodiments, the SAB branch includes two parallel convolution layers of different sizes to convolve an input feature (e.g., FIG. 7).

At block 1207, the method 1100 continues by reconstructing the residual features to form a residual map. At block 1209, the method 1200 continues to add the residual map to the input image based on the enhanced portion of the residual feature to generate a reconstructed image. Embodiments of the reconstructed image are discussed with reference to FIG. 1.

In some embodiments, the method 1200 can include performing a loss function to train the reconstructed image such that the reconstructed image is close to a raw image.

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A method for video processing, comprising:
receiving an input image;
extracting shallow features of the input image through a head network;
determining, based on the shallow features, residual features of the input image and enhancing a portion of the residual features by two or more weakly-connected-dense-attention-blocks (WCDABs);
reconstructing the residual features to form a residual map; and
adding the residual map to the input image to generate a reconstructed image.

2. The method of claim 1, wherein the WCDAB includes two or more residual attention blocks (RABs).

3. The method of claim 2, wherein the RAB includes a dual-branch structure, wherein convolutional layers of the dual-branch structure are depth-wise separable convolutional layers, and wherein the depth-wise separable convolutional layer includes a depth-wise part and a point-wise part.

4. The method of claim 3, wherein the dual-branch structure includes a first branch and a second branch, wherein the first branch includes a first convolutional layer with a first dimension, and wherein the second branch includes two second convolutional layers with a second dimension.

5. The method of claim 4, wherein the first dimension is the same as the second dimension.

6. The method of claim 5, wherein the first dimension is three by three (3×3).

7. The method of claim 4, wherein the first convolutional layer with the first dimension corresponds to a first receptive field, and wherein the two second convolutional layers correspond a second receptive field.

8. The method of claim 7, wherein the second receptive field is greater than the first receptive field.

9. The method of claim 7, wherein the first receptive field is a three-by-three (3×3) field, and wherein second receptive field is a five-by-five (5×5) field.

10. The method of claim 7, wherein the RAB is configured to perform a channel shuffling operation to integrate features from the first receptive field and the second receptive field.

11. The method of claim 10, wherein the RAB is configured to form a common convolution layer after the channel shuffling operation, wherein the common convolution layer is configured to perform a channel dimensionality reduction operation so as to form a feature map.

12. The method of claim 11, wherein the RAB includes a channel attention block (CAB) module configured to emphasize channels in the feature map.

13. The method of claim 1, wherein the WCDAB includes a CSAB module configured to enhance the portion of the residual features, and wherein the CSAB module includes a channel-attention-block (CAB) branch and a spatial attention block (SAB) branch.

14. The method of claim 13, wherein the CAB branch is configured to process an input feature from two or more RABs of the WCDAB to form a channel attention map, and wherein the SAB branch is configured to process the input feature to form a spatial attention map.

15. The method of claim 14, further comprising merging the channel attention map and the spatial attention map to form a channel-spatial joint attention map.

16. The method of claim 13, wherein the SAB branch includes two parallel convolution layers of different sizes to convolve an input feature.

17. A system for video processing, comprising:
a processor;
a memory configured to store instructions, which when executed by the processor, cause the processor to:
receive an input image;
extracting shallow features of the input image through a head network;
determine, based on the shallow features, residual features of the input image and enhance a portion of the residual features by two or more weakly-connected-dense-attention-blocks (WCDABs);
reconstruct the residual features to form a residual map; and
add the residual map to the input image to generate a reconstructed image.

18. The system of claim 17, wherein the instructions are further to:
perform a dual-branch operation by two or more residual attention blocks (RABs) of the WCDABs;
wherein the dual-branch operation includes a first branch and a second branch, wherein the first branch includes a first convolutional layer with a first dimension, and wherein the second branch includes two second convolutional layers with the first dimension.

19. A method for video processing, comprising:
receiving an input image;
retrieving residual information of the input image by two or more weakly-connected-dense-attention-blocks (WCDABs);
processing the residual information by two or more residual attention blocks (RABs) of each of the WCDAB, wherein the RAB includes a dual-branch structure having depth-wise separable convolutions having first and second branches, wherein the first branch includes a first convolutional layer with a first dimension, and wherein the second branch includes two second convolutional layers with the first dimension;
enhancing the residual information by a channel-spatial-attention-block (CSAB) module of the WCDABs to form enhanced residual information; and
generating a reconstructed image based on the enhanced residual information and the input image.

20. The method of claim 19, wherein the CSAB module includes a channel-attention-block (CAB) branch and a spatial attention block (SAB) branch, wherein the CAB branch is configured to process an input feature from the RABs to form a channel attention map, and wherein the SAB branch is configured to process the input feature from the RABs to form a spatial attention map, and wherein a channel-spatial joint attention map is formed by merging the channel attention map and the spatial attention map.
